(19) United States
(12) Patent Application Publication
(10) Pub. No.: US 2023/0248035 A1
(43) Pub. Date: Aug. 10, 2023

(54) TASTE-ENHANCING COMPOSITION

(71) Applicant: INTERNATIONAL FLAVORS & FRAGRANCES INC., NEW YORK, NY (US)

(72) Inventors: Hsi-Wen CHIN, Tinton Falls, NJ (US); Yongbo YUAN, Wallingford, PA (US)

(21) Appl. No.: 18/015,897

(22) PCT Filed: Jul. 19, 2021
(86) PCT No.: PCT/US2021/042166

§ 371 Date: Jan. 12, 2023

Related U.S. Application Data
(60) Provisional application No. 63/053,119, filed on Jul. 17, 2020.

(51) Int. Cl. A23L 27/00; A23L 27/24; A23L 27/22; A23L 5/20; A23L 23/00

(52) U.S. Cl. CPC A23L 27/88; A23L 27/24; A23L 27/22; A23L 5/273; A23L 23/00

(57) ABSTRACT

A taste enhancing composition comprising plants from the Apiaceae family and having a taste-effective glutamate content along with a method of producing a taste enhancer by reducing biotin in a fermentable carbohydrate prior to bacterial fermentation are provided.

### BACKGROUND OF THE INVENTION

Today's food product consumers are interested in purchasing food products that offer convenience and deliciousness with labeling declarations that are simple and understandable. Consumers do not want to see ingredients on food labels that seem overly chemical, artificial or that are unrecognizable. Instead, consumers want to see food product ingredients that they are familiar with and that seem wholesome and natural. This consumer desire for wholesome, natural ingredients can pose a challenge for food formulators designing products with enhanced taste profiles including savory products in which ingredients like monosodium glutamate (MSG) have been used traditionally but have become less desirable to consumers. As a result, food formulators have investigated processes like fermentation to generate taste enhancers that can be used and labeled with familiar ingredient names like the names of the vegetative matter used as the fermentation substrate.

Fermentation has been used to produce amino acids in food. See Hashimoto, Adv. Biochem. Eng., Biotechnology 159: 15-34 (2017). Researcher Chiaki Sano explains how fermentation can be used to generate amino acids like glutamate in the article “History of glutamate production,” Am J Clin Nutr 90 (suppl): 728S-32S (2009). In that article, Sano explains that glutamate accumulation in fermentations involving coryneform bacteria only occurs under biotin-limiting conditions. Because desirable raw materials like sugar molasses have too much biotin, it became necessary to add compounds like antibiotics and surfactants to the fermentation to mitigate the negative effects of biotin. These additional compounds can detract from the image of the process as being completely natural. Other efforts focus on cleaner processes of preparing glutamate. See Dong et al., J Cleaner Production 190: 452-461 (2018).

In WO2015/020292, C J Cheiljedang Corp explains that fermented taste enhancers require both nucleic acids and glutamic acid and thus they go on to describe a two-step fermentation process involving a first fungal fermentation followed by a bacterial fermentation. Such complicated processing schemes lead to increased expense.

In U.S. Pat. No. 8,790,728, Nestec describes a coryneform bacterial fermentation using an enzymatically hydrolyzed substrate in a process to create a savory base. This reference suggests enzymatically hydrolyzing starch to create the substrate used in the fermentation, which results in a more complicated manufacturing process and detracting from the image of the process as being completely natural.

Plants such as carrots have been fermented to prepare beverage and flavor. See, e.g., CN108125086A, CN105982108A, CN101632472A, and CN107236767A. However, there is no indication that a high level of glutamate is generated in these processes.

Thus, there is a need for an improved, more natural and wholesome process for generating glutamate.

### SUMMARY OF THE INVENTION

Our inventions relate to a method of making a taste enhancer comprising the steps of reducing biotin in a first fermentable carbohydrate to create a low-biotin first fermentable carbohydrate followed by bacterial fermentation. In some embodiments, the biotin reduction step involves mixing the first fermentable carbohydrate with an activated charcoal and in some embodiments, the bacterial fermentation step uses Corynebacterium glutamicum, Corynebacterium ammoniagenes, Corynebacterium casei, Brevibacterium lactofermentum, Bacillus subtilis or combinations thereof.

Additionally, our inventions relate to a food product comprising a taste enhancer and a food base wherein the taste enhancer comprises a first fermentable carbohydrate from the plant family Apiaceae and glutamate at a level of from about 15% to about 55% w/w.

Further, our inventions relate to a taste enhancing composition comprising a first fermentable carbohydrate from the plant family Apiaceae wherein the taste enhancing composition has a glutamate content of from about 15% to about 55% w/w.

### BRIEF DESCRIPTION OF THE DRAWINGS

FIG. 1 shows the effect of biotin level in fermentation media on glutamate content in the taste enhancer.

FIG. 2 shows the effect of taste enhancer on the descriptive profile of beef stock.

FIG. 3 shows the comparative effect of monosodium glutamate and taste enhancer on the descriptive profile of beef stock.

### OVERVIEW

1. A taste enhancing composition comprising a first fermentable carbohydrate from the plant family Apiaceae wherein the taste enhancing composition has a glutamate content of from about 15% to about 55% w/w.
2. The taste enhancing composition as in claim 1, wherein the taste enhancing composition has a glutamate content of from about 15% to about 40% w/w.
3. The taste enhancing composition as in claim 1, wherein the first fermentable carbohydrate is Daucus carota subsp. sativus.
4. The taste enhancing composition as in claim 1, wherein the first fermentable carbohydrate is carrot juice, carrot puree, carrot pomace, or combinations thereof
5. The taste enhancing composition as in claim 1, further comprising at least one other component.
6. The taste enhancing composition as in claim 5, wherein the at least one other component is a second fermentable carbohydrate, a supplemental carbon source, or combinations thereof.
7. The taste enhancing composition as in claim 6, wherein the supplemental carbon source is glucose, fructose, sucrose, maltose, a high fructose corn syrup, a starch hydrolysate, a cellulose hydrolysate, or combinations thereof
8. The taste enhancing composition as in claim 6, wherein the second fermentable carbohydrate is from the plant family Apiaceae.
9. The taste enhancing composition as in claim 6, wherein the second fermentable carbohydrate is Daucus carota subsp. sativus.
10. The taste enhancing composition as in claim 6, wherein the second fermentable carbohydrate is carrot juice, carrot puree, carrot pomace, or combinations thereof, preferably carrot pomace.
11. The taste enhancing composition as in claim 1, further comprising at least one organic acid.
12. The taste enhancing composition as in claim 11, wherein the at least one organic acid is lactic acid, citric acid, acetic acid, succinic acid, and combinations thereof
13. The taste enhancing composition as in claim 11 wherein the amount of organic acid is less than about 15% w/w.
14. A taste enhancing composition made from a process comprising the steps of reducing biotin in a first fermentable carbohydrate to create a low-biotin first fermentable carbohydrate followed by a bacterial fermentation step.
15. The taste enhancing composition as in claim 14, wherein the taste enhancing composition has a glutamate content of from about 15% to about 55% w/w.
16. The taste enhancing composition as in claim 14, wherein the low-biotin first fermentable carbohydrate has a biotin content of less than 10 μg per liter.
17. The taste enhancing composition as in claim 14, wherein the low-biotin first fermentable carbohydrate has a biotin content of less than 4.9 μg per liter.
18. The taste enhancing composition as in claim 14, wherein the first fermentable carbohydrate is from the plant family Apiaceae.
19. The taste enhancing composition as in claim 14, wherein the first fermentable carbohydrate is Daucus carota subsp. sativus.
20. The taste enhancing composition as in claim 14, wherein the first fermentable carbohydrate is carrot juice, carrot puree, carrot pomace, or combinations thereof
21. The taste enhancing composition as in claim 14, wherein the biotin reduction step comprises mixing the first fermentable carbohydrate with activated charcoal.
22. The taste enhancing composition as in claim 21, wherein the mixing step has a mixing temperature from about 30° C. to about 60° C. and a mixing time of from about 40 to about 80 minutes.
23. The taste enhancing composition as in claim 21, further comprising a step of removing the activated charcoal prior to bacterial fermentation.
24. The taste enhancing composition as in claim 14, further comprising admixing at least one other component with the low-biotin first fermentable carbohydrate to create a fermentation substrate prior to the bacterial fermentation step.
25. The taste enhancing composition as in claim 24, wherein the fermentation substrate has a biotin content of less than 10 μg per liter.
26. The taste enhancing composition as in claim 24, wherein the fermentation substrate has a biotin content of less than 4.9 μg per liter.
27. The taste enhancing composition as in claim 24, wherein the at least one other component is a second fermentable carbohydrate, a supplemental carbon source, or combinations thereof
28. The taste enhancing composition as in claim 27, wherein the supplemental carbon source is glucose, fructose, maltose, sucrose, a high fructose corn syrup, a starch hydrolysate, a cellulose hydrolysate, or combinations thereof
29. The taste enhancing composition as in claim 27, wherein the second fermentable carbohydrate is from the plant family Apiaceae.
30. The taste enhancing composition as in claim 27, wherein the second fermentable carbohydrate is Daucus carota subsp. sativus.
31. The taste enhancing composition as in claim 27, wherein the second fermentable carbohydrate is a carrot juice, a carrot puree, a carrot pomace, or combinations thereof
32. The taste enhancing composition as in claim 14, wherein the bacterial fermentation step uses Corynebacterium glutamicum, Corynebacterium ammoniagenes, Corynebacterium casei, Brevibacterium lactofermentum, Bacillus subtilis or combinations thereof
33. The taste enhancing composition as in claim 14, wherein the bacterial fermentation has a temperature of from about 28° C. to about 40° C.
34. The taste enhancing composition as in claim 14, wherein the bacterial fermentation has a time of from about 10 to about 72 hours, preferably from about 15 to about 27 hours, more preferably from about 40 to about 72 hours.
35. The taste enhancing composition as in claim 14, wherein the bacterial fermentation has a pH of from about 5 to about 10, preferably from about 5 to about 9.5.
36. The taste enhancing composition as in claim 14, wherein the bacterial fermentation has a dissolved oxygen content of from about 5% to about 50%, preferably from about 15% to about 40%, and more preferably from about 20% to about 30%.
37. The taste enhancing composition as in claim 14, further comprising the step of autoclaving following the bacterial fermentation.
38. The taste enhancing composition as in claim 37, further comprising the step of removing biomass after the autoclaving step to create a supernatant and then drying the supernatant.
39. The taste enhancing composition as in claim 14, further comprising the step of activated charcoal treatment following the bacterial fermentation.
40. The taste enhancing composition as in claim 39, wherein the activated charcoal treatment has a temperature of from about 40 C to about 60 C and a treatment time of from about 30 minutes to about 90 minutes.
41. The taste enhancing composition as in claim 39, wherein the activated charcoal is used at an amount of from about 0.1% w/vol to about 1.0% w/vol, preferably from about 0.1% w/vol to about 0.5% w/vol, and even more preferably from about 0.1% w/vol to about 0.3% w/vol.
42. The taste enhancing composition as in claim 14, wherein the first fermentable carbohydrate is from the plant family Apiaceae.
43. The taste enhancing composition as in claim 27, wherein the first and second fermentable carbohydrates are from the plant family Apiaceae.
44. A food product comprising the taste enhancing composition as in claim 14 and a food product base.
45. A method of making a taste enhancer comprising the steps of reducing biotin in a first fermentable carbohydrate to create a low-biotin first fermentable carbohydrate followed by bacterial fermentation.
46. The method as in claim 45, wherein the biotin reduction step comprises mixing the first fermentable carbohydrate with an activated charcoal.
47. The method as in claim 46, wherein the first fermentable carbohydrate is a liquid with a solids content of from about 30% to about 50%.
48. The method as in claim 46, wherein the activated charcoal is added in an amount of from about 0.75% to about 2.0% w/w.
49. The method as in claim 46, wherein the mixing step proceeds at from about 30 C to about 60 C for from about 40 to about 80 minutes.
50. The method as in claim 46, further comprising the step of removing the activated charcoal prior to bacterial fermentation.
51. The method as in claim 45, wherein the biotin reduction step is conducted more than once prior to bacterial fermentation.
52. The method as in claim 45, wherein the low-biotin first fermentable carbohydrate has a biotin content of less than 10 μg of biotin per liter.
53. The method as in claim 45, wherein the low-biotin first fermentable carbohydrate has a biotin content of less than 4.9 μg of biotin per liter.
54. The method as in claim 45, wherein the first fermentable carbohydrate is from the plant family Apiaceae.
55. The method as in claim 45, wherein the first fermentable carbohydrate is Daucus carota subsp. sativus.
56. The method as in claim 45, wherein the first fermentable carbohydrate is a carrot juice, a carrot puree, a carrot pomace, or combinations thereof
57. The method as in claim 45, further comprising the step of mixing at least one other component with the low-biotin first fermentable carbohydrate to create a fermentation substrate prior to the bacterial fermentation step.
58. The method as in claim 57, wherein the fermentation substrate has a biotin content of less than 10 μg of biotin per liter.
59. The method as in claim 57, wherein the fermentation substrate has a biotin content of less than 4.9 μg per liter.
60. The method as in claim 57, wherein the at least one other component is a supplemental carbon source, a second fermentable carbohydrate or combinations thereof
61. The method as in claim 60, wherein the supplemental carbon source is glucose, fructose, maltose, a high fructose corn syrup, a starch hydrolysate, a cellulose hydrolysate, sucrose, or combinations thereof
62. The method as in claim 60, wherein the second fermentable carbohydrate is from the plant family Apiaceae.
63. The method as in claim 60, wherein the second fermentable carbohydrate is Daucus carota subsp. sativus.
64. The method as in claim 60, wherein the second fermentable carbohydrate is a carrot juice, a carrot puree, a carrot pomace, or combinations thereof
65. The method as in claim 45, wherein the bacterial fermentation uses Corynebacterium glutamicum, Corynebacterium ammoniagenes, Corynebacterium casei, Brevibacterium lactofermentum, Bacillus subtilis or combinations thereof
66. The method as in claim 45, wherein the bacterial fermentation has a temperature of from about 28 C to about 40 C.
67. The method as in claim 45, wherein the bacterial fermentation has a time of from about 10 to about 72 hours, preferably from about 15 to about 27 hours, more preferably from about 40 to about 72 hours.
68. The method as in claim 45, wherein the bacterial fermentation has a pH of from about 5 to about 10, preferably from about 5 to about 9.5.
69. The method as in claim 45, wherein the bacterial fermentation has a dissolved oxygen content of from about 5% to about 50%, preferably from about 15% to about 40%, and more preferably from about 20% to about 30%.
70. The method as in claim 45, further comprising the step of autoclaving following the bacterial fermentation.
71. The method as in claim 70, further comprising the step of removing biomass after the autoclaving step to create a supernatant and then drying the supernatant.
72. The method as in claim 71, wherein the supernatant has a glutamate content of from about 15% to about 55% grams/liter.
73. The method as in claim 71, wherein the dried supernatant has a glutamate content of from about 15% to about 55% w/w.
74. The method as in claim 45, wherein the taste enhancer has a glutamate content of from about 15% to about 55% w/w.
75. The method as in claim 45, further comprising the step of biotin mitigation.
76. The method as in claim 75, wherein the biotin mitigation step can include addition of an antibiotic, addition of a surfactant, or combinations thereof
77. The method as in claim 76, wherein the antibiotic can include penicillin and the surfactant can include Spans, Tweens, or combinations thereof
78. A method of enhancing the taste of a food product comprising the steps of reducing biotin in a fermentable carbohydrate from the plant family Apiaceae followed by bacterial fermentation to generate a taste enhancer and then adding an organoleptically effective amount of the taste enhancer to a food product base.
79. The method as in claim 78, wherein the food product shows a significant increase in umami when measured by descriptive analysis.
80. The method as in claim 78, wherein the food product shows a significant increase in richness/mouthfeel when measured by descriptive analysis.
81. The method as in claim 78, wherein the food product shows a significant increase in juiciness/mouthwatering when measured by descriptive analysis.
82. A method of enhancing umami in a food product comprising the steps of reducing biotin in a fermentable carbohydrate from the plant family Apiaceae followed by bacterial fermentation to generate an umami enhancer and then adding an organoleptically effective amount of the umami enhancer to a food product base.
83. The method as in claim 82, wherein the food product shows a significant increase in umami when measured by descriptive analysis.
84. The method as in claim 82, wherein the food product has an umami attribute score of at least 5 on a scale of 1 to 10 when measured by descriptive analysis.
85. A method of enhancing mouthfeel in a food product comprising the steps of reducing biotin in a fermentable carbohydrate from the plant family Apiaceae followed by bacterial fermentation to generate a mouthfeel enhancer and then adding an organoleptically effective amount of the mouthfeel enhancer to a food product base.
86. The method as in claim 85, wherein the food product shows a significant increase in richness/mouthfeel when measured by modified QDA.
87. The method as in claim 85, wherein the food product has a richness/mouthfeel attribute score of at least 3 on a scale of 1 to 10 when measured by modified QDA.
88. The method as in claim 85, wherein the food product has a juiciness/mouthwatering score of at least 5 on a scale of 1 to 10 when measured by modified QDA.
89. A food product comprising a taste enhancer and a food base wherein the taste enhancer comprises a fermentable carbohydrate from the plant family Apiaceae and the taste enhancer has a glutamate content of from about 15% to about 55% w/w.
90. The food product as in claim 89, wherein the taste enhancer has a glutamate content of from about 15% to about 40% w/w.
91. The food product as in claim 89, wherein the food product has an umami attribute score of from about 6 to about 8 on a scale of 1 to 10 as measured by modified QDA.
92. The food product as in claim 89, wherein the food product has a significantly increased umami attribute, salty perception attribute, juiciness/mouthwatering attribute, beefiness attribute, richness/mouthfeel attribute, or combinations thereof as measured by modified QDA compared to the food base.
93. The food product as in claim 89, wherein the taste enhancer is present in an amount of from about 0.001% to about 1% w/w by weight of the food product.
94. The food product as in claim 89, wherein the taste enhancer is present in an amount of at least about 0.005% w/w by weight of the food product.
95. The food product as in claim 89, wherein the taste enhancer is present in an amount of from about 0.01% to about 1% w/w by weight of the food product.
96. The food product as in claim 89, wherein the food base is culinary bases, soups, sauces, bouillons, ready-to-eat cereals, salty snacks, pet foods, beverages, pastas, prepared meals, dietary supplements, medicaments, or combinations thereof.

### DETAILED DESCRIPTION OF THE INVENTION

To overcome the challenges of too much biotin in the fermentation media used to generate taste enhancing compositions, these inventors have developed a taste enhancing composition and uses a low-biotin fermentation media that can be made from a process that begins by reducing the level of biotin in a natural substrate rather than employing conventional methods of adding artificial compounds that mitigate the adverse effects of high biotin levels to the substrate. As a result, the taste enhancing composition has a high taste enhancement efficacy and the process is surprisingly simple and natural. These taste enhancing compositions and their uses have been found beneficial in imparting an olfactory effect taste enhancement and/or somatosensory effect to food products. In particular, these taste enhancing compositions provide umami taste, salt taste, flavor enhancement, mouthfeel effects, or overall flavor profile preference.

In some embodiments, the taste enhancing composition includes a fermentable carbohydrate. Some embodiments can include more than one fermentable carbohydrate such as a first fermentable carbohydrate and a second fermentable carbohydrate. As used herein, for either the first and/or second fermentable carbohydrate, “fermentable carbohydrate” is understood to mean fruit or vegetable materials with a sufficient saccharide content for fermentation. Some non-limiting examples of fermentable carbohydrates include carrot puree (10% solids) containing 3.8% saccharides; carrot juice concentrate (40° Brix) containing 28% saccharides; celery puree (5% solids) containing 1.8% saccharides; celery juice concentrate (45° Brix) containing 24% saccharides; pumpkin puree (6% solids) containing 2.1% saccharides; pumpkin juice concentrate (40° Brix) containing 2.8% saccharides; parsnip puree (20% solids) containing 4.8% saccharides; parsnip juice concentrate (60° Brix) containing 45% saccharides; tomato juice concentrate (45° Brix) containing 31% saccharides; beet juice concentrate (40° Brix) containing 47% saccharides; grape juice concentrate (70° Brix) containing 51% saccharides; honey white clover (80° Brix) containing 70% saccharides, or combinations thereof.

The inventors have surprisingly found that fermentable carbohydrates from the plant family Apiaceae work particularly well in the inventive process to create highly effective taste enhancing compositions. Plants in this family include parsley (Petroselinum crispum), carrot (Daucus carota), celery (Apium graveolens), parsnip (Pastinaca sativa), and fennel (Foeniculum vulgare). In particular, the root vegetable Daucus carota subsp. sativus sometimes known as carrot provides a consumer-friendly, natural, cost-effective source of fermentable carbohydrates. This is surprising because these plants are known to have high levels of biotin. But, by using the inventive biotin-reduction step in the inventive process, these plants can be effectively used to create high potency taste enhancing compositions. In some embodiments, plants from the Apiaceae family are used as the first fermentable carbohydrates, while in other embodiments, those plants are used as the second fermentable carbohydrate and in still other embodiments, these plants are used for both the first and second fermentable carbohydrate.

The root vegetable carrot is farmed in a number of geographies and provides a range of agricultural products including carrot juice, carrot puree, and carrot pomace. As used herein, “carrot juice” is understood to mean the soluble material resulting from the extraction of raw carrots. Carrot juice is commercially available in both liquid and dry formats. As used herein, “carrot puree” is understood to mean mashed carrots. As used herein, “carrot pomace” is understood to mean the insoluble material resulting from the extraction of raw carrots to separate the soluble and insoluble components. Because carrot pomace is considered a waste stream material, embodiments using carrot pomace further contribute to a sustainable food supply. Depending on the embodiment, various Apiaceae agricultural products can be used and combined. For example, the first fermentable carbohydrate can be a carrot juice and the second fermentable carbohydrate can be carrot pomace.

In some embodiments, the taste enhancing composition includes from about 15% to about 55% w/w of glutamate when the taste enhancing composition is a dry material and from about 15% to about 55% of glutamate when the taste enhancing composition is a liquid material. In other embodiments, the taste enhancing composition includes from about 15% to about 40% w/w of glutamate when the taste enhancing composition is a dry material and from about 15% to about 40% of glutamate when the taste enhancing composition is a liquid material. In still other embodiments, the level of glutamate in the taste enhancing composition is from about 15%, 20%, 25%, 30%, 35%, 40%, 45%, or 50% to about 20%, 25%, 30%, 35%, 40%, 45%, 50% or 55% w/w. This level of glutamate contributes to the taste enhancing efficacy of the taste enhancing composition.

In some embodiments, the taste enhancing composition also includes a supplemental carbon source. As used herein, “supplemental carbon source” is understood to mean a saccharide material that provides a ready source of carbon to the bacteria in the bacterial fermentation. In some embodiments, the supplemental carbon source can include glucose, fructose, maltose, high fructose corn syrup, starch hydrolysate, cellulose hydrolysate, sucrose, or combinations thereof.

In some embodiments, the taste enhancing composition also includes an organic acid. In some embodiments, the organic acid can include lactic acid, citric acid, acetic acid, succinic acid, and combinations thereof. In some embodiments, the amount of organic acid in the taste enhancing composition is below about 15% w/w, while in other embodiments, the organic acid amount is less than about 10%, less than about 7%, less than about 5%, less than about 1%, or less than about 0.5% w/w.

Regarding the method of making a taste enhancing composition, in some embodiments the method includes a step of reducing biotin in a first fermentable carbohydrate to create a low-biotin first fermentable carbohydrate followed by a bacterial fermentation. Unlike other methods of making taste enhancing compositions in which antibiotics and surfactants have been used to mitigate high levels of biotin in fermentable carbohydrates, the inventive process reduces biotin before conducting the bacterial fermentation. This process for making taste enhancing compositions enables the use of fermentable carbohydrates that would otherwise not be considered desirable due to their biotin content.

In some embodiments, there is a first fermentable carbohydrate and in other embodiments there is also a second fermentable carbohydrate. Such fermentable carbohydrates can include plants from the plant family Apiaceae including, but not limited to, the root vegetable Daucus carota subsp. sativus known as carrot. In some embodiments, there is a first fermentable carbohydrate that can be carrot juice, carrot puree, carrot pomace, or combinations thereof. In other embodiments, there is a second fermentable carbohydrate that can be carrot juice, carrot puree, carrot pomace, or combinations thereof. In still other embodiments, the first fermentable carbohydrate is carrot juice and the second fermentable carbohydrate is carrot pomace.

In some embodiments, the biotin reduction step includes mixing activated charcoal with a first fermentable carbohydrate prior to bacterial fermentation to create a low-biotin first fermentable carbohydrate. As used herein, “activated charcoal”, also known as activated carbon and terms can be used interchangeably, is understood to mean a solid, porous, carbonaceous material prepared by carbonizing and activating organic substrates.

In some embodiments, the biotin reduction step creates a low-biotin first fermentable carbohydrate with less than 10 μg/L of biotin, e.g., less than 4.9 μg/L, less than 3.6 μg/L, less than 1.8 μg/L, and less than 0.5 μg/L. In some embodiments, the level of biotin in the low-biotin first fermentable carbohydrate is less than 9.5 μg/L, 9 μg/L, 8.5 μg/L, 8 μg/L, 7.5 μg/L, 7 μg/L, 6.5 μg/L, 6 μg/L, 5.5 μg/L, 5 μg/L, 4.9 μg/L, 4.5 μg/L, 4 μg/L, 3.6 μg/L, 3.5 μg/L, 3 μg/L, 2.5 μg/L, 2 μg/L, 1.8 μg/L, 1.5 μg/L, 1 μg/L, 0.5 μg/L, or 0.25 μg/L.

In some embodiments in which the biotin reduction step involves mixing the first fermentable carbohydrate with activated charcoal, the first fermentable carbohydrate is a liquid with a solids content from about 30% to about 50%. In other embodiments, the liquid first fermentable carbohydrate has a solids content of from about 30%, 35%, 40%, or 45% to about 35%, 40%, 45%, or 50%.

In some embodiments, the activated charcoal is added in an amount from about 0.75% to about 2%. In other embodiments, activated charcoal is added in an amount from about 0.75%, 0.8%, 0.85%, 0.9%, 0.95%, 1%, 1.05%, 1.1%, 1.15%, 1.2%, 1.25%, 1.3%, 1.35%, 1.4%, 1.45%, 1.5%, 1.55%, 1.6%, 1.65%, 1.7%, 1.75%, 1.8%, 1.85%, 1.9%, or 1.95% to about 0.8%, 0.85%, 0.9%, 0.95%, 1%, 1.05%, 1.1%, 1.15%, 1.2%, 1.25%, 1.3%, 1.35%, 1.4%, 1.45%, 1.5%, 1.55%, 1.6%, 1.65%, 1.7%, 1.75%, 1.8%, 1.85%, 1.9%, 1.95%, or 2.9%.

In some embodiments using activated charcoal for the biotin reduction step, the mixing step can have a temperature of about 30 C to about 60 C. In other embodiments, the mixing temperature can be from about 30 C, 35 C, 40 C, 45 C, 50 C, or 55 C to about 35 C, 40 C, 45 C, 50 C, 55 C, or 60 C. Conventional techniques for temperature monitoring and maintenance can be used and will be known to those of skill in the art. Non-limiting examples can include the use of temperature-controlled, jacketed mixing kettles and the like. Additionally, in some activated charcoal embodiments, the mixing step can have a time from about 40 to about 80 minutes. In other embodiments, the biotin reduction mixing time can be from about 40, 45, 50, 55, 60, 65, 70, or 75 minutes to about 45, 50, 55, 60, 65, 70, 75, or 80 minutes.

In some embodiments involving the use of activated charcoal, the activated charcoal is removed following the mixing step. In some embodiments, the activated charcoal removal step can include filtration, centrifugation, or combinations thereof. These removal processes can include any conventional means and will be familiar to those of ordinary skill in the art.

In some embodiments in which the fermentable carbohydrates need additional biotin reduction, the biotin reduction step can be conducted more than once prior to bacterial fermentation. For example, a fermentable carbohydrate can be mixed with activated charcoal and then centrifuged to remove the activated carbon to create a fermentable carbohydrate supernatant that can then be mixed with activated charcoal a second or third time until a desirable level of biotin is reached.

In some embodiments, the method of making the taste enhancing composition further includes a step of mixing the first fermentable carbohydrate or low-biotin first fermentable carbohydrate with at least one other component to create a fermentation substrate. This additional mixing step can have advantages such as providing additional substrates for the bacterial fermentation to produce a high amount of glutamate.

In embodiments in which the at least one additional component is mixed with the low-biotin first fermentable carbohydrate, the at least one additional component is selected such that the resulting fermentation substrate still has a low level of biotin. In embodiments with the at least one additional component, the fermentation substrate has a level of biotin less than 10 μg of biotin per liter (μg/L), while in other embodiments, the fermentation substrate has less than 4.9 μg/L or 3.6 μg/L of biotin, and in still other embodiments, the biotin content is below 1.8 μg/L, and in still others, the biotin content is less than 0.5 μg/L. In some embodiments, the level of biotin in the fermentation substrate is less than 9.5 μg/L, 9 μg/L, 8.5 μg/L, 8 μg/L, 7.5 μg/L, 7 μg/L, 6.5 μg/L, 6 μg/L, 5.5 μg/L, 5 μg/L, 4.9 μg/L, 4.5 μg/L, 4 μg/L, 3.6 μg/L, 3.5 μg/L, 3 μg/L, 2.5 μg/L, 2 μg/L, 1.8 μg/L, 1.5 μg/L, 1 μg/L, 0.5 μg/L, or 0.25 μg/L.

In some embodiments, the at least one additional component is a second fermentable carbohydrate, a supplemental carbon source, or combinations thereof. The supplemental carbon source can be glucose, fructose, sucrose, maltose, a high fructose corn syrup, a starch hydrolysate, a cellulose hydrolysate, or combinations thereof.

In some embodiments, the first fermentable carbohydrate is from the plant family Apiaceae, while in other embodiments, the second fermentable carbohydrate is from the plant family Apiaceae, and in still other embodiments, both the first and second fermentable carbohydrates are from the plant family Apiaceae. For example, a carrot juice is used as the first fermentable carbohydrate subject to the biotin reduction step of mixing with activated charcoal to create a low-biotin first fermentable carbohydrate with a biotin content of less than 10 μg/L. That low-biotin, activated charcoal treated carrot juice can then be combined with carrot pomace, which does not contribute biotin to create a fermentation substrate that still has less than 10 μg/L of biotin. To further aid the subsequent bacterial fermentation, a sugar such as sucrose can be added for a three-component fermentation substrate having less than 10 μg/L of biotin.

As to the particular bacteria to be used in the bacterial fermentation step of the method of making a taste enhancer, in some embodiments, the bacterial fermentation uses Corynebacterium glutamicum, Corynebacterium ammoniagenes, Corynebacterium casei, Brevibacterium lactofermentum, Bacillus subtilis or combinations thereof. In some embodiments, the bacterium is Corynebacterium glutamicum. The inventors have found that by using one or more of these bacteria, a natural taste enhancer can be produced with a glutamate content from about 15% to about 40% w/w or 15% to about 55% w/w when the taste enhancing composition is a dry material and from about 15% to about 40% g/l or 15% to about 55% g/l of glutamate when the taste enhancing composition is a liquid material. In other embodiments, the level of glutamate in the taste enhancing composition is from about 15%, 20%, 25%, 30%, 35%, 40%, 45%, or 50% to about 20%, 25%, 30%, 35%, 40%, 45%, 50%, or 55% w/w or g/ml. This level of glutamate contributes to the taste enhancing efficacy of the taste enhancing composition.

Some processing variables related to the bacterial fermentation step include fermentation temperature, time, pH, and dissolved oxygen content. For fermentation temperature, in some embodiments, the temperature can be from about 28 C to about 40 C. In other embodiments, the temperature can be from about 28 C, 30 C, 32 C, 35 C, 37 C, or 39 C to about 30 C, 32 C, 35 C, 37 C, 39 C, or 40 C. For fermentation time, in some embodiments, the fermentation continues from about 10 hours to about 72 hours. In some preferred embodiments, the time is from about 15 hours to about 27 hours, while in still other more preferred embodiments, the time is from about 40 hours to about 72 hours. In some embodiments, the fermentation time is from about 10, 15, 20, 25, 30, 35, 40, 45, 50, 55, 60, 65, or 70 hours to about 15, 20, 25, 30, 35, 40, 45, 50, 55, 60, 65, 70 or 72 hours.

For the pH of the bacterial fermentation step, in some embodiments, the pH is from about 5 to about 10 and in some preferred embodiments, the pH is from about 5 to about 9.5. In other embodiments, the pH is from about 5, 5.5, 6, 6.5, 7, 7.5, 8, 8.5, 9, or 9.5 to about 5.5, 6, 6.5, 7, 7.5, 8, 8.5, 9, 9.5 or 10. Any conventional means of pH control can be used for achieving this pH range. For example, the addition of an ammonium hydroxide solution (for example, a 28% w/vol solution of ammonium hydroxide or a 1:1 v/v mixture of ammonium hydroxide 28% solution and sodium hydroxide 21% solution) can be used to maintain the pH in the desired range.

In some embodiments, the dissolved oxygen content of the bacterial fermentation step is maintained in a range of from about 5% to about 50%, preferably from about 15% to about 40%, and more preferably from about 20% to about 30%. In other embodiments, the dissolved oxygen is maintained in a range from about 5%, 10%, 15%, 20%, 25%, 30%, or 35% to about 10%, 15%, 20%, 25%, 30%, 35%, or 40%. Maintaining the dissolved oxygen can impact the fermentation efficiency and can be controlled in a number of ways that will be apparent to those of skill in the art. For example, changing the rate of agitation can increase the dissolved oxygen content as can an increase in aeration rate.

In some embodiments, the method of making the taste enhancer can further include additional steps following bacterial fermentation. In some embodiments, the step of autoclaving can follow the bacterial fermentation step. This autoclaving step can end the bacterial fermentation by killing the bacteria. Such autoclaving can occur at a temperature of 121 C for about 15 minutes. Autoclaving can be done using conventional processing and such autoclaving processes will be known to those of ordinary skill in the art.

In some embodiments, the step of removing biomass is conducted following the autoclaving step to create a supernatant. As with autoclaving, the biomass removal step can employ any conventional means such as filtering, centrifuging and the like. These biomass removal processes will be known to those of ordinary skill in the art. For this step, the autoclaved, fermented mass can be subject to centrifugation to separate out the biomass. In some embodiments, the autoclaved, fermented mass is subjected to centrifugation at 10,000×g (unit for relative centrifugal force) for 15 minutes to obtain a taste enhancing supernatant composition. Any conventional centrifuge that can provide sufficient relative centrifugal force can be used and will be familiar to those of skill in the art.

To obtain a powdered taste enhancing composition, the supernatant can then be dried. Here again, those of skill in the art will be familiar with the various drying techniques that can be used to generate the powdered taste enhancing composition. Non-limiting examples of the drying step can involve conventional processes such as spray drying, freeze drying, vacuum drying, fluid bed drying, tray drying, flash drying, drum drying and the like as known by those of ordinary skill in the art.

For methods of making a taste enhancer using the additional autoclaving and biomass removal steps, the resulting supernatant has a glutamate content of from about 15% to about 55% or g/ml. In other embodiments, the supernatant has a glutamate content of from about 15% to about 40% or g/ml. In still other embodiments, the level of glutamate in the supernatant is from about 15%, 20%, 25%, 30%, 35%, 40%, 45% or 50% to about 20%, 25%, 30%, 35%, 40%, 45%, 50% or 55% or g/ml. In embodiments in which the supernatant is dried, the dried supernatant has a glutamate content of from about 15% to about 55% w/w. In other embodiments, the dried supernatant has a glutamate content of from about 15% to about 40% w/w. In still other embodiments, the level of glutamate in the dried supernatant is from about 15%, 20%, 25%, 30%, 35%, 40%, 45% or 50% to about 20%, 25%, 30%, 35%, 40%, 45%, 50% or 55% w/w.

Another post-fermentation treatment that can help remove off-tastes is to treat the autoclaved fermented mass or the taste enhancing supernatant composition with activated charcoal. In some embodiments, the activated carbon is packed into a chromatography column through which the supernatant is passed. In those embodiments, the supernatant can have a temperature from about 40 C to about 60 C prior to being passed through the column. In other embodiments, the supernatant can be mixed with activated carbon after which the activated carbon is removed. In still other embodiments, the fermented mass can be mixed with activated carbon, and then the activated carbon can be removed. In embodiments in which the activated carbon is mixed with either the fermented mass or supernatant, the mixture temperature can be from about 40 C to about 60 C. In those embodiments, the activated carbon can be added in an amount of from about 0.1% w/vol to about 1.0% w/vol, preferably from about 0.1% w/vol to about 0.5% w/vol, and even more preferably from about 0.1% w/vol to about 0.3% w/vol. Also, in those embodiments with activated carbon, the supernatant mixing step can proceed for from about 30 minutes to about 90 minutes.

In some embodiments, the method of making a taste enhancer further includes a biotin mitigation step in addition to the biotin reduction step. This biotin mitigation step can enhance the method by contributing to the level of glutamate in the taste enhancer. In some embodiments, the biotin mitigation step includes the addition of an antibiotic, a surfactant, or combinations thereof during fermentation. In other embodiments, the biotin mitigation step includes the addition of penicillin, Tweens (also known as ethoxylated or polyethoxylated sorbitan esters), Spans (also known as sorbitan esters), lecithin, acetylated monoglycerides, mono and diglycerides, stearic acid, sucrose monopalmitate, sugar esters, or combinations thereof. In some embodiments, the surfactants can have a hydrophilic-lipophilic balance (HLB) of from about 10 to about 20, while in other embodiments, the surfactant includes Tween 40, Tween 80, or combinations thereof.

The natural, efficacious taste enhancing composition product made by the process described above can then be admixed with a food product base to create a food product with enhanced taste. As used herein, the term “food product” includes both solid and liquid ingestible materials for humans and animals. These food products can include, but are not limited to, meats; gravies; soups; convenience foods; alcoholic and non-alcoholic beverages; milk and dairy products; seafood including fish, crustaceans, mollusks and the like; confectionery; vegetable products; fruit products; cereal products including ready-to-eat cereals; baked goods; salty snacks; crackers; biscuits; culinary bases; sauces; bouillons; pastas; prepared meals; soft drinks; snacks; pet foods; pet treats; galenical products; medicaments; and dietary supplements. As used herein, “food product base” is understood to mean any and all components of a food product minus the taste enhancing composition.

In some embodiments, the food product includes a combination of the taste enhancing composition and a taste modifier. Such co-ingredient taste modifiers can include sodium chloride (salt), ribonucleotides, inosine monophosphate, guanosine monophosphate, monosodium glutamate, yeast, amino acid blends, peptides, arginine hydrochloride, arginine ammonium chloride, lysine hydrochloride, lysine-ornithine hydrochloride, and the like.

These inventors have also developed a method of enhancing the taste of a food product comprising the steps of reducing biotin in a fermentable carbohydrate from the plant family Apiaceae followed by bacterial fermentation to generate a taste enhancer and then adding an organoleptically effective amount of the taste enhancer to a food product base. As used herein “organoleptically effective amount” is understood to mean the amount of taste enhancer that will contribute to particular olfactory characteristics of the food product, but the flavor, taste, and aroma of the food product will be the sum of the effects of each of the food product components. As used herein, the taste effects can include, salt, mouthfeel, and/or umami effects. Thus, the taste enhancers of the of the invention can be used to modify the taste characteristics of food products by modifying the taste reaction contributed by another ingredient in the food product. The specific amount will vary depending on many factors such as the other ingredients in the food product, their relative amounts, and the desired effect.

In some preferred embodiments, the taste effect is umami and using an organoleptically effective amount of the taste enhancer increases the umami-ness of the food product. In some embodiments, the food product shows a significant increase in umami when measured by descriptive analysis. In some embodiments, the food product shows a significant increase in juiciness/mouthwatering when measured by descriptive analysis.

These inventors have also developed a method of enhancing umami in a food product comprising the steps of reducing biotin in a fermentable carbohydrate from the plant family Apiaceae followed by bacterial fermentation to generate an umami enhancer and then adding an organoleptically effective amount of the umami enhancer to a food product base. In some embodiments, the food product shows a significant increase in umami when measured by descriptive analysis. In other embodiments, the food product has an umami attribute score of at least 5 on a scale of 1 to 10 as measured by descriptive analysis.

These inventors have developed a method of enhancing mouthfeel in a food product comprising the steps of reducing biotin in a fermentable carbohydrate from the plant family Apiaceae followed by bacterial fermentation to generate a mouthfeel enhancer and then adding an organoleptically effective amount of the mouthfeel enhancer to a food product base. In some embodiments, the food product shows a significant increase in richness/mouthfeel when measured by descriptive analysis. In other embodiments, the food product has a richness/mouthfeel attribute score of at least 3 on a scale of 1 to 10 when measured by descriptive analysis. And in still other embodiments, the food product has a juiciness or mouthwatering score of at least 5 on a scale of 1 to 10 when measured by descriptive analysis.

The inventors have further developed a food product comprising a taste enhancer and a food base wherein the taste enhancer comprises a fermentable carbohydrate from the plant family Apiaceae and includes from about 15% to about 55% w/w glutamate. In some embodiments, the taste enhancer includes from about 15% to about 40% w/w glutamate.

In some embodiments, the amount of taste enhancer is from about 0.001% to about 10% w/w of the food product. In some embodiments, the amount of taste enhancer is from about 0.001% to about 1% w/w, while in other embodiments, the amount of taste enhancer is from about 0.01% to about 1%, while in still other embodiments, the taste enhancer amount is at least 0.005% w/w. In some embodiments, the amount of taste enhancer is from about 0.005% w/w to about 10% w/w, from about 0.005% w/w to about 7% w/w, from about 0.01% w/w to about 5% w/w, from about 0.05% w/w to about 10% w/w, from about 0.1% w/w to about 5% w/w, or from about 0.5% w/w to about 1% w/w of the food product.

The amount of taste enhancer can vary based on the type of food base involved. In some embodiments in which the food base is a soup, the amount of taste enhancer is from about 0.005% to about 1.5% w/w; while for embodiments in which the food base is a meat product, the amount of taste enhancer is from about 0.005 to about 1.0% w/w; while for still other embodiments in which the food base is a condiment, the amount of taste enhancer is from about 0.005 to about 0.5% w/w; and for embodiments in which the food base is a savory snack, the taste enhancer amount is from about 0.005 to about 0.5% w/w.

The terms “include,” “includes,” and “including,” are meant to be non-limiting.

All publications cited herein are incorporated by reference in their entirety.

The following are provided as specific embodiments of the present invention. Other modifications of this invention will be readily apparent to those skilled in the art. Such modifications are understood to be within the scope of this invention. As used herein, all percentages are weight percent unless otherwise noted, ppm is understood to stand for parts per million, L or l is understood to be liter, mL is understood to be milliliter, g is understood to be gram, Kg is understood to be kilogram, μg is understood to be microgram, mol is understood to be mole, mmol is understood to be millimole, psig is understood to be pound-force per square inch gauge, and mmHg be millimeters (mm) of mercury (Hg). IFF as used in the examples is understood to mean International Flavors & Fragrances Inc., New York, N.Y., USA.

### Examples 1-3: Effect of Fermentation Media on Glutamate Content

To investigate the effect of using various carrot materials on the glutamate content of a taste enhancer, one kilogram of carrot juice (40% solids sourced from Florida Food Products in Eutis, Fla., USA) was heated to 50 C with agitation and then mixed with 10 g of powdered, activated carbon (NuChar® SA-20, Ingredi, Wilkes-Barre, Pa.). The temperature and agitation were maintained for one hour after which the activated carbon was removed from the juice by centrifugation at 10,000×g for fifteen minutes at room temperature.

Next, a seed culture of Corynebacterium glutamicum was prepared by transferring 1 milliliter (mL) of frozen C. glutamicum stock to 200 mL of seed culture medium that was then incubated at 30 C with 250 revolutions per minute (rpm) orbital shaking for 20 hours. The seed culture medium was prepared by diluting 40% solids carrot juice (Florida Food Products) with tap water to create a 10% solution. After incubation, the optical density at 600 nanometer (nm) was 0.9 when a sample of the seed culture was diluted 20×.

The main fermentation was carried out by blending the carrot materials as shown in Table 1 in a 2-liter Eppendorf fermenter. The pH of the fermentation was maintained between 7.2 to 7.9 by adding a 28% solution of ammonium hydroxide. The dissolved oxygen of the fermentation was maintained between 20% and 30%. After the fermentation time as shown in Table 1, each broth was autoclaved to end the fermentation and centrifuged to remove the biomass and create a supernatant that was then dried to a powder. HPLC analysis of the powders showed the glutamate and lactic acid contents as shown in Table 1.

TABLE 1
Effect of Fermentation Media on Glutamate Content

| | Example 1 | | Example 2 | | Example 3 | |
|---|---|---|---|---|---|---|
| Activated | 500 | g/Liter | 75 | g/Liter | 60 | g/Liter |
| carbon treated | | | | | | |
| carrot juice | | | | | | |
| Carrot pomace* | | | 50 | g/Liter | 20 | g/Liter |
| Carrot puree** | 150 | g/Liter | | | | |
| Sucrose | | | 110 | g/Liter | 120 | g/Liter |
| Fermentation | 72 | hours | 48 | hours | 48 | hours |
| time | | | | | | |

| | | | |
|---|---|---|---|
| Glutamate | 15.08% w/w | 28% w/w | 40% w/w |
| content | of the | of the | of the |
| | dried powder | dried powder | dried powder |
| Lactic acid | 11.14% w/w | 9% w/w | 1.7% w/w |
| content | of the | of the | of the |
| | dried powder | dried powder | dried powder |

*Bolthouse Farms, Bakersfield, CA, USA
**Bolthouse Farms, Bakersfield, CA, USA

### Example 4: Effect of Biotin Reduction on Glutamate Content

Having obtained positive results in the tests described in Examples 1-3, the investigators next explored the effect of biotin reduction on the glutamate content of the taste enhancer. The following treatments were conducted:
(1) Control juice without carbon treatment
   Six-hundred grams of carrot juice (66.6% solids; Ernteband Fruchtsaft GmbH, Winnenden, Germany) were diluted with 400 g water to prepare one liter carrot juice at 40% solids. The diluted juice was used directly in the fermentation without carbon treatment. The diluted juice was analyzed for biotin content by LC-MS-MS.
(2) Treatment with 0.5% (w/w) activated carbon
   Six-hundred grams of carrot juice (66.6% solids; Ernteband Fruchtsaft GmbH, Winnenden, Germany) were diluted with 400 g water to prepare one liter carrot juice at 40% solids. The diluted juice was heated to 50 C with agitation and then thoroughly mixed with 5 g powder activated carbon. The activated carbon was immediately removed from the juice by centrifugation at 10,000×g for 15 minutes at room temperature to obtain a supernatant. The supernatant obtained was analyzed by LC-MS-MS for biotin content.
(3) Treatment with 1% (w/w) activated carbon
   Six-hundred grams of carrot juice (66.6% solids; Ernteband Fruchtsaft GmbH, Winnenden, Germany) were diluted with 400 g water to prepare one liter carrot juice at 40% solids. The diluted juice was heated to 50 C with agitation and then mixed with 10 g powder activated carbon. The temperature and agitation were maintained for 1 hour Activated carbon was removed from the juice by centrifugation at 10,000×g for 15 minutes at room temperature to obtain a supernatant. The supernatant obtained was analyzed by LC-MS-MS for biotin content.
(4) Treatment with 1.5% (w/w) activated carbon
   Six-hundred grams of carrot juice (66.6% solids; Ernteband Fruchtsaft GmbH, Winnenden, Germany) were diluted with 400 g water to prepare one liter carrot juice at 40% solids. The diluted juice was heated to 50 C with agitation, and then mixed with 15 g powder activated carbon. The temperature and agitation were maintained for 1 hour. Activated carbon was removed from the juice by centrifugation at 10,000×g for 15 minutes at room temperature to obtain a supernatant. The supernatant obtained was analyzed by LC-MS-MS for biotin content.
(5) Treatment with 1% (w/w) activated carbon two times
   Six-hundred grams of carrot juice (66.6% solids; Ernteband Fruchtsaft GmbH, Winnenden, Germany) were diluted with 400 g water to prepare one liter carrot juice at 40% solids. The diluted juice was heated to 50 C with agitation, and then mixed with 10 g powder activated carbon. The temperature and agitation were maintained for 1 hour. Activated carbon was removed from the juice by centrifugation at 10,000×g for 15 minutes at room temperature to obtain a supernatant. The supernatant was then treated the second time using the same process, and the supernatant obtained from the second treatment was analyzed for biotin content by LC-MS-MS.

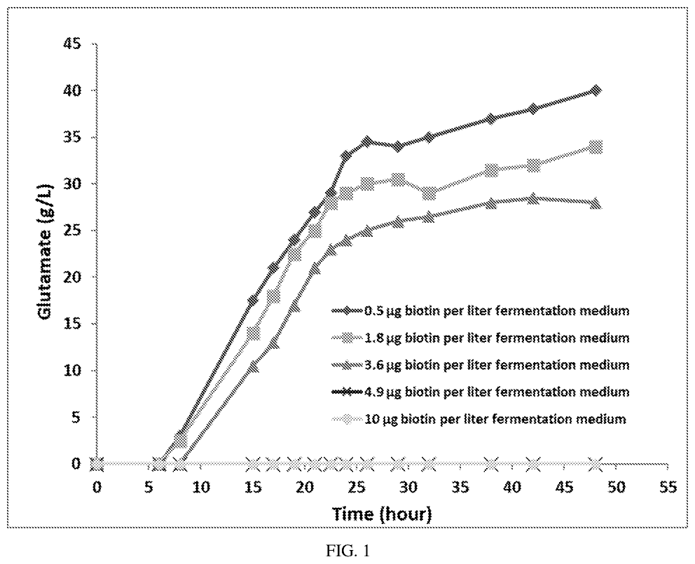

The preparation of seed culture was the same as described in Examples 1-3. The main fermentation was carried out using the medium containing the carbon-treated carrot juice, carrot pomace, and sucrose (Table 2) in a 2-L Eppendorf fermenter. The pH value of the fermenting medium was maintained between 7.2 to 7.9 during fermentation, and controlled by the addition of ammonium hydroxide (28%). Dissolved oxygen (DO) was maintained between 20 to 30%. A sample of the fermenting medium was periodically obtained during fermentation for the analysis of glutamate. The production of glutamate during fermentation was shown in FIG. 1, expressed as glutamate titers (gram glutamate per liter of fermentation medium).

Table 2 below shows the various treatments with the corresponding levels of biotin.

TABLE 2
Effect of Carbon Treatment on Biotin Content

| Fermentation | | | | | | | | | | |
|---|---|---|---|---|---|---|---|---|---|---|
| Substrate | Treatment #1 | | | | | | | | | |
| Component | Control | | Treatment #2 | | Treatment #3 | | Treatment #4 | | Treatment #5 | |
| Carrot pomace* | 3 | g/L | 3 | g/L | 3 | g/L | 3 | g/L | 3 | g/L |
| Carrot juice | 60 g/L | | 60 g/L | | 60 g/L | | 60 g/L | | 60 g/L | |
| | without | | treated with | | treated with | | treated with | | treated with | |
| | activated | | 0.5% activated | | 1% activated | | 1.5% activated | | 1% activated | |
| | carbon treatment | | carbon | | carbon | | carbon | | carbon 2 times | |
| Sucrose | 160 | g/L | 160 | g/L | 160 | g/L | 160 | g/L | 160 | g/L |
| Biotin content | 10 | μg/L | 4.9 | μg/L | 3.6 | μg/L | 1.8 | μg/L | 0.5 | μg/L |
| in fermentation | | | | | | | | | | |
| medium | | | | | | | | | | |

*Ernteband Fruchtsaft GmbH, Winnenden, Germany

FIG. 1 provides a visual representation of the data shown above. As seen in the chart of FIG. 1, lowering the biotin content to values below 4.9 μg per liter sharply increases the glutamate content in the taste enhancer.

### Example 5: Effect of Post-Fermentation Carbon Treatment on Taste

In addition to reducing the amount of biotin in the carrot juice used for fermentation, carbon treatment can also be used after fermentation to generate a taste enhancer with improved taste characteristics. The following post-fermentation treatments were conducted:

Carrot juice (40% solids) was treated with 1% activated carbon two times as described in Treatment #5 of Example 4. The preparation of seed culture was also as described in Example 1. The main fermentation was carried out using the fermentation substrate containing carrot pomace, the carbon-treated carrot juice, and sucrose (Fermentation Substrate as in Treatment #5 and Table 2 of Example 4) in a 2-L Eppendorf fermenter. The pH value of the fermenting medium was maintained between 7.2 to 7.6 during fermentation, and controlled by the addition of ammonium hydroxide (28%). DO was maintained at 20%. After 48 hours of fermentation, the broth was autoclaved at 121 C for 15 minutes and the following post-fermentation treatments were conducted:
(1) Two-hundred grams of the autoclaved fermentation broth were centrifuged at 10,000×g for 15 minutes to remove biomass without carbon treatment, and the supernatant was dried to powder.
(2) Two-hundred grams of the autoclaved fermentation broth were centrifuged at 10,000×g for 15 minutes to remove biomass, and the supernatant (pre-heated to 50 C) was passed through a bed of activated carbon (2 g) packed in a chromatography column. The eluate was passed through the column one more time, and the second eluate was dried to powder.
(3) Two-hundred grams of the autoclaved fermentation broth were pre-heated to 50 C, and then 0.4 g powder activated carbon (0.2%) was added with agitation at 100 rpm. The temperature and agitation were maintained for 1 hour. Activated carbon and biomass were removed by centrifugation at 10,000×g for 15 min, and the supernatant was dried to powder.
(4) Two-hundred grams of the autoclaved fermentation broth were pre-heated to 50 C, and then 1.0 g powder activated carbon (0.5%) was added with agitation at 100 rpm. The temperature and agitation were maintained for 1 hour. Activated carbon and biomass were removed by centrifugation at 10,000×g for 15 minutes, and the supernatant was dried to powder.

The powder samples from each post-fermentation treatment were dissolved in water (0.3%) and subjected to taste tests by a technical panel of eight judges. All panelists described the carbon-treated samples as cleaner with less cooked and bitter off tastes (Table 3).

TABLE 3
Effect of Post-Fermentation Carbon Treatment on Taste

| | Post-Fermentation | Post-Fermentation | Post-Fermentation | Post-Fermentation |
|---|---|---|---|---|
| | Treatment #1 | Treatment #2 | Treatment #3 | Treatment #4 |
| Carbon | None | Chromatography | Batch mode at | Batch mode at |
| Treatment | | mode | 0.2% | 0.5% |
| Glutamate | 27.5% | 30.5% | 29.2% | 30% |
| Content on | | | | |
| Dry Weight | | | | |
| Basis | | | | |
| Taste | Savory & umami; | Savory & umami; | Savory & umami; | Clean savory & |
| description | somewhat bitter & | much less bitter | less bitter & | umami; profiles |
| | mouth drying; | and mouth drying | mouth drying than | similar to Sample |
| | lingering umami; | than Sample 1; | Sample 1, but | 2 |
| | pronounced | cooked off-flavors | more than Sample | |
| | cooked off-flavors | significantly | 2; cooked off- | |
| | | reduced | flavors reduced | |

### Example 6: Effect of Taste Enhancer on Taste of Chicken Stock

The powder product obtained according to post-fermentation Treatment #2 was used in a chicken stock base formula as shown in Table 4.

TABLE 4
Formula for chicken stock base

| Ingredient | Amount | |
|---|---|---|
| Chicken scraps, blanched | 800 | g |
| Mirepoix | 300 | g |
| Bay leaves | 2 | pieces |
| Thyme sprigs | 3 | pieces |
| Salt | 10 | g |
| Black peppercorns | 10 | pieces |
| Garlic cloves, crushed | 15 | g |
| Red chilies | pinch | |
| Water | 2400 | g |

To make the chicken stock, the mixture was brought to a boil and left to simmer for 2 hours. After cooling to 70 C, the powder product obtained according to post-fermentation Treatment #2 was added to the stock at 0.3% (w/w). A technical panel of eight judges tasted the test sample containing the test product against a control/blank chicken stock sample. All panelists described the test sample as more savory/umami with better mouthfeel.

### Example 7: Effect of Taste Enhancer on Descriptive Profile of Beef Stock

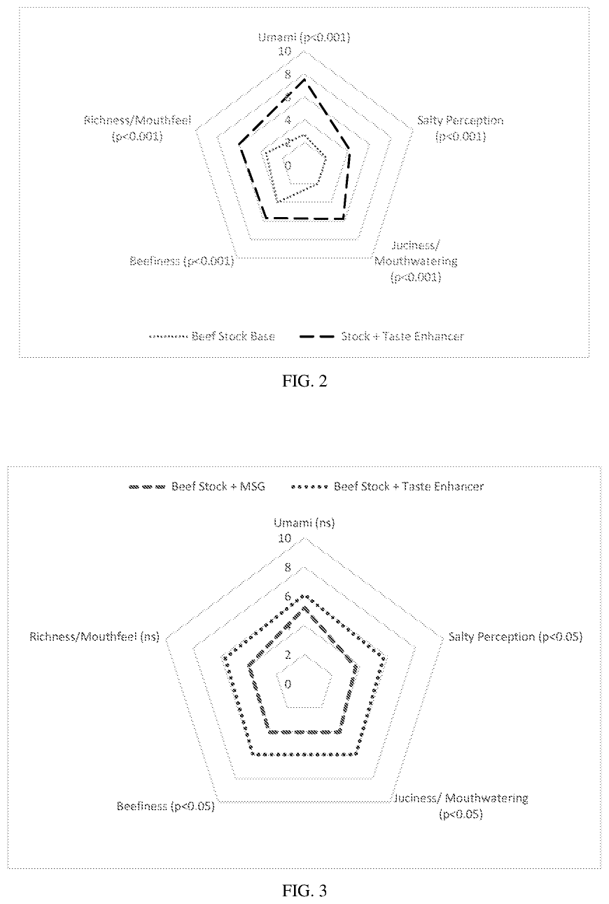

Descriptive sensory testing was conducted to evaluate the powdered taste enhancer product on pre-selected sensory attributes. The sensory testing followed a modified version of quantitative descriptive analysis (“modified QDA”). The modifications included using unstructured scales with verbal anchors at each end. The control/blank sample was a beef stock base (Table 5), whereas the test sample contained 0.2% (w/w) of the powder product obtained according to Example 3 from Table 1. Sample pairs were presented in a blind and random order to a sensory panel. Panelists were instructed to score the attribute intensity by placing a vertical line at the appropriate point on a line scale of 10 centimeters (cm) with the lowest intensity point on the left. The powder product obtained according to Example 3 significantly enhanced the intensity of umami, salty perception, juiciness/mouthwatering, beefiness, and richness/mouthfeel in beef stock base as shown in FIG. 2.

TABLE 5
Formula and Preparation of Beef Stock Base

| Ingredient | Amount | |
|---|---|---|
| Beef short ribs | 1500 | g |
| Mirepoix | 150 | g |
| Tomatoes | 40 | g |
| Bay leaves | 2 | pieces |
| Thyme sprigs | 2 | pieces |
| Salt | 5 | g |
| Black peppercorns | 8 | pieces |
| Garlic cloves, crushed | 10 | g |
| Red chili flakes | 0.15 | g |
| Water | 3300 | g |

1. Beef ribs are oven roasted at 250 F. for 2 hours
2. Water, roasted ribs, vegetables and spices are brought to a boil
and left to simmer for 2 hours (impurities are skimmed periodically)
3. After cooled to room temperature, the mixture is strained through
cheesecloth

### Example 8: Effect of Monosodium Glutamate on Descriptive Profile of Beef Stock

Descriptive sensory testing was conducted to evaluate the powdered taste enhancer product on pre-selected sensory attributes. The control sample was a beef stock base (Table 5) containing 0.2% (w/w) of the powder product obtained according to Example 3 from Table 1, whereas the test sample contains 0.092% (w/w) of monosodium glutamate. Both the control and test samples therefore contain the same amount of the glutamate radical. Sample pairs were presented in a blind and random order to a sensory panel. Panelists were instructed to score the attribute intensity by placing a vertical line at the appropriate point on a line scale of 10 cm with the lowest intensity point on the left. The powdered taste enhancer product obtained according to Example 3, when compared to the same amount of glutamate, significantly enhanced the intensity of salty perception, juiciness/mouthwatering, and beefiness in the beef stock base as shown in FIG. 3.

### Example 9: Range of Use Levels of Taste Enhancer in Beef Stock as Measured by Technical Taste Panel

A series of test samples were prepared in the beef stock base of Table 5. These test samples contained varying amounts of the powdered taste enhancer product obtained according to Example 3 from Table 1, ranging from 0.001% (w/w), 0.005%, 0.01%, 0.1%, 0.5%, 1.0%, 1.5%, 2.0%, to 2.5%. A technical panel of six judges tasted the sample series from the lowest to the highest, and were asked to select the samples that were unbearable to taste due to undesirable attributes. As a result, all judges selected samples containing 1.5%, 2.0%, and 2.5% as unbearable to taste due to strong sourness imparted by the product. Thus, a suggested use level for the taste enhancer with beef stock would be below 1.5% w/w and a range of use levels would include from about 0.001% to about 1.5% w/w.

### Example 10: Use Levels of Taste Enhancer for Impacting Umami in Beef Stock as Measured by Difference Testing

A test sample was prepared in the beef stock base of Table 5 containing 0.005% (w/w) of the powder taste enhancer product obtained according to Example 3 from Table 1. The control/blank sample was the beef stock base. Sample pairs were presented in a blind and random order to a sensory panel. Panelists were instructed to select the sample that had higher umami intensity. Binomial statistical analysis was performed on judges' selections, and indicated that there was no statistical significance in umami intensity between the blank/control and test samples.

Then, a test sample was prepared in the beef stock base of Table 5 containing 0.01% (w/w) of the powder product obtained according to Example 3 from Table 1. The control/blank sample was the beef stock base. Sample pairs were presented in a blind and random order to a sensory panel. Panelists were instructed to select the sample that had higher umami intensity. Binomial statistical analysis was performed on judges' selections, and indicated that the powder product applied at 0.01% (w/w) in the beef stock base was significantly more umami than the blank sample (p<0.01). These tests suggest that a use level of the powdered taste enhancer in beef stock could be an amount greater than 0.005% w/w and/or an amount greater than or equal to about 0.01% w/w.

### Example 11. Effect of Vegetable Oil as Antifoam Agent During Fermentation

Carrot juice (40% solids sourced from Florida Food Products in Eutis, Fla., USA) was treated with activated charcoal as in Examples 1 to 3. The main fermentation was carried out as in Example 3 (Table 1) in a 2-liter Eppendorf fermenter equipped with a foam sensor which, when in contact with the rising foam, automatically activated a pump to add drops of an antifoam agent to the fermenter until the foams subsided. When sunflower oil was used as the antifoam agent instead of the commonly used silicone-based antifoam, a greater quantity of glutamate was produced (51 g per liter fermentation broth).

What is claimed is:

1. A method of making a taste enhancer comprising the steps of reducing biotin in a first fermentable carbohydrate to create a low-biotin first fermentable carbohydrate followed by bacterial fermentation.

2. The method as in claim 1, wherein the biotin reduction step comprises mixing the first fermentable carbohydrate with an activated charcoal.

3. The method as in claim 2, wherein the activated charcoal is added in an amount of from about 0.75% to about 2.0% w/w.

4. The method as in claim 1, wherein the low-biotin first fermentable carbohydrate has a biotin content of less than 10 μg of biotin per liter.

5. The method as in claim 1, wherein the first fermentable carbohydrate is from the plant family Apiaceae.

6. The method as in claim 1, wherein the first fermentable carbohydrate is a carrot juice, a carrot puree, a carrot pomace, or combinations thereof.

7. The method as in claim 1, further comprising the step of mixing at least one other component with the low-biotin first fermentable carbohydrate to create a fermentation substrate prior to the bacterial fermentation step.

8. The method as in claim 7, wherein the at least one other component is a supplemental carbon source, a second fermentable carbohydrate or combinations thereof.

9. The method as in claim 8, wherein the second fermentable carbohydrate is a carrot juice, a carrot puree, a carrot pomace, or combinations thereof.

10. The method as in claim 1, wherein the bacterial fermentation uses Corynebacterium glutamicum, Corynebacterium ammoniagenes, Corynebacterium casei, Brevibacterium lactofermentum, Bacillus subtilis or combinations thereof.

11. The method as in claim 1, wherein the taste enhancer has a glutamate content of from about 15% to about 55% w/w.

12. A food product comprising a taste enhancer and a food base wherein the taste enhancer comprises a fermentable carbohydrate from the plant family Apiaceae and the taste enhancer has a glutamate content of from about 15% to about 55% w/w.

13. The food product as in claim 12, wherein the taste enhancer is present in an amount of from about 0.001% to about 1% w/w by weight of the food product.

14. The food product as in claim 12, wherein the food product has a significantly increased umami, salty perception, juiciness/mouthwatering, beefiness, richness/mouthfeel, or combinations thereof as measured by quantitative descriptive analysis compared to the food base.

15. A taste enhancing composition comprising a first fermentable carbohydrate from the plant family Apiaceae wherein the taste enhancing composition has a glutamate content of from about 15% to about 55% w/w.

16. The taste enhancing composition as in claim 15, wherein the first fermentable carbohydrate is a carrot juice, a carrot puree, a carrot pomace, or combinations thereof.

17. The taste enhancing composition as in claim 15, further comprising at least one other component.

18. The taste enhancing composition as in claim 17, wherein the at least one other component is a second fermentable carbohydrate, a supplemental carbon source, or combinations thereof.

19. The taste enhancing composition as in claim 18, wherein the second fermentable carbohydrate is from the plant family Apiaceae.

20. The taste enhancing composition as in claim 18, wherein the second fermentable carbohydrate is a carrot juice, a carrot puree, a carrot pomace, or combinations thereof.

21. The taste enhancing composition as in claim 15, further comprising at least one organic acid.
